(19) United States
(12) Patent Application Publication
(10) Pub. No.: US 2021/0333426 A1
(43) Pub. Date: Oct. 28, 2021

(54) Geological Data Integrity Verification System

(71) Applicant: Landmark Graphics Corporation, Houston, TX (US)

(72) Inventor: Dominic Allan Rorke, Wallingford (GB)

(21) Appl. No.: 16/331,651

(22) PCT Filed: Mar. 22, 2018
(86) PCT No.: PCT/US2018/023876

§ 371 Date: Mar. 8, 2019

(51) Int. Cl. G01V 1/34; G06T 17/05; E21B 49/00

(52) U.S. Cl. CPC G01V 1/34; G06T 17/05; G01V 2210/624; G01V 2200/14; E21B 49/00

(57) ABSTRACT

Embodiments of the subject technology provide for receiving a geologic point corresponding to at least one of a well pick or outcrop data, the geologic point being associated with a lithologic attribute. The subject technology intersects the geologic point with a geologic map polygon to identify an intersecting geologic point of the geologic map polygon. The subject technology performs an integrity check for the geologic point based at least in part on lithologic attributes of the geologic point and the intersecting geologic point. Further, when the geologic point fails the integrity check, the subject technology provides an indication that the geologic point failed the integrity check to facilitate providing an accurate representation of the formation corresponding to the geologic map polygon.

### TECHNICAL FIELD

The present description generally relates to verifying the integrity of geologic data, including verifying the integrity of geological map data.

### BACKGROUND

Geologic maps may be generated based on geologic data and/or other sources of data.

### BRIEF DESCRIPTION OF THE DRAWINGS

FIG. 1 conceptually illustrates an example interface for presenting detected geological data integrity errors in accordance with some implementations.

FIG. 2 conceptually illustrates an example flowchart of a process of a geological data integrity verification system in accordance with some implementations.

FIG. 3 illustrates an example table including integrity checks for comparing attributes of points with attributes of intersected polygons in accordance with some implementations.

FIG. 4 conceptually illustrates an example flowchart of a process for comparing an attribute of a point with an attribute related to a depositional environment of an intersected polygon based on one or more integrity checks in accordance with some implementations.

FIG. 5A illustrates an example table including attributes for a relative depth of a depositional environment in accordance with some implementations.

FIG. 5B illustrates an example schematic diagram of a cross-section through depositional sequences with time intervals in accordance with some implementations.

FIG. 6 illustrates a schematic diagram of a set of general components of an example computing device in accordance with some implementations.

FIG. 7 illustrates a schematic diagram of an example of an environment for implementing aspects in accordance with some implementations.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

A workflow in geoscience relates to the interpretation of wells and outcrops, and the generation of geologic maps from these interpretations. Once generation of a geologic map is complete, it may be desirable from a quality assurance perspective, to verify the integrity of the geologic map with respect to the input data points. In addition, interpretations of well and outcrop data may change over time, or new data may be acquired, which can result in an update to the geologic map. Each time a geologic map is updated, it may be desirable to re-verify the integrity of the geologic map to facilitating ensuring that the updated map is compliant with the input data points.

Geologic maps may include a representation of the distribution of rocks and other geologic materials of different lithology attributes and periods of time over the Earth's surface and/or below the surface (e.g., the subsurface). A geoscientist measures and describes the rock sections and plots the different rock formations for including on a geologic map, which can show a distribution of such rock formations. In an example, a geologic map produced via subsurface mapping techniques can be a valuable tool for locating underground features that may form traps or outline the boundaries of a possible reservoir with petroleum deposits. Further, a geologic map can be generated via three dimensional subsurface mapping techniques by using well data (e.g., well logs) and may help determine the underground geology of a large area. In this manner, a given geologic map generated by subsurface mapping techniques can be used to show, for example, the geology of petroleum deposits found in a given reservoir. After a reservoir has been discovered, the geoscientist may be responsible to present evidence to support the development and production of that reservoir (e.g., a drilling operation) by a given oil and/or gas company. Implementations of the subject technology therefore facilitate the verification of geologic attributes included in a geologic map to provide a more accurate geologic map, which may then be relied upon by the geoscientist to more successfully solve the problem of finding and recovering hydrocarbons in connection with the exploration for oil and gas.

In prior techniques, features derived from a geologic point dataset were manually overlain over geologic map polygons that formed areas of different geologic attributes in a geologic map. A geoscientist would then laboriously visually review the map with overlain point features to determine inconsistencies between a combination of attributes of the point features and the geologic map polygons. This approach was prone to user error due to potential inconsistent application of rules to assess whether an overlain point feature and geologic map polygon combination was valid, resulting in a geologic map that was less reliable in representing geologic attributes when used by the geoscientist. Implementations of the subject technology provide techniques to improve quality assurance of geologic data in a given geologic map by utilizing spatial and/or attribute integrity checks to verify the attribution of geologic point datasets (e.g., well picks or outcrops) against geologic map polygons (e.g., representing areas of different lithology or depositional facies that form the geologic map) that each geologic point may intersect. A failure of a point to pass one or more integrity checks may indicate that: 1) a change in the location or attribution of a point may be needed, or 2) a change in the geometry or attribution of the map polygon may be needed. The subject technology may detect inconsistencies between interpreted geologic point datasets and map polygons, and may indicate such inconsistencies on displayed geologic maps, thereby identifying the areas of the geologic map where additional review may be needed to harmonize interpretations of the geologic data and/or resolve inconsistencies between attributes of points and polygons.

The following discussion describes, in further detail, an example graphical interface for highlighting inconsistencies with respect to geologic data, example flowcharts for a process for detecting issues in lithology attributes of geologic data using integrity checks and for a process that verifies attributes with integrity checks related to depositional environments (e.g., depth integrity checks), and diagrams illustrating example integrity checks for verifying lithology attributes and integrity checks related to depositional environments.

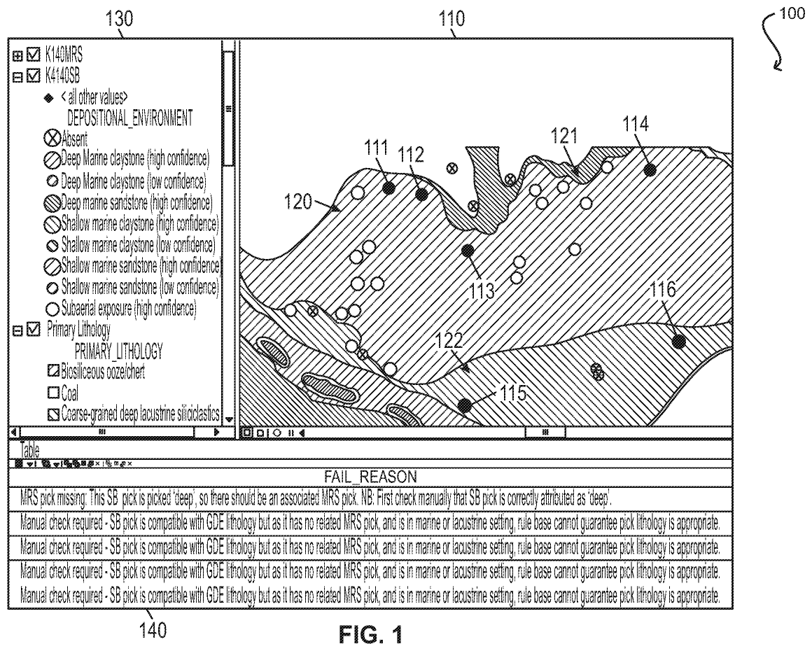

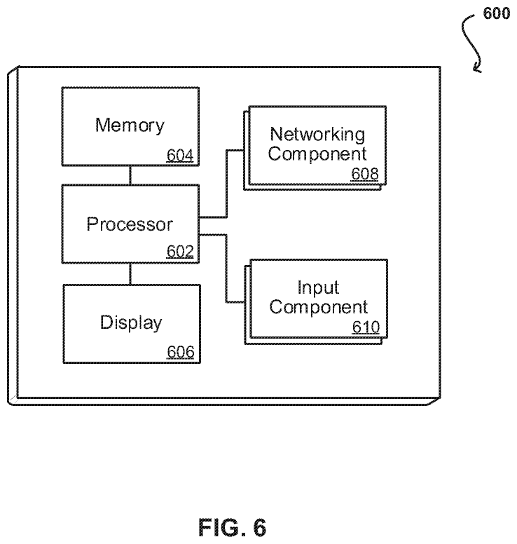

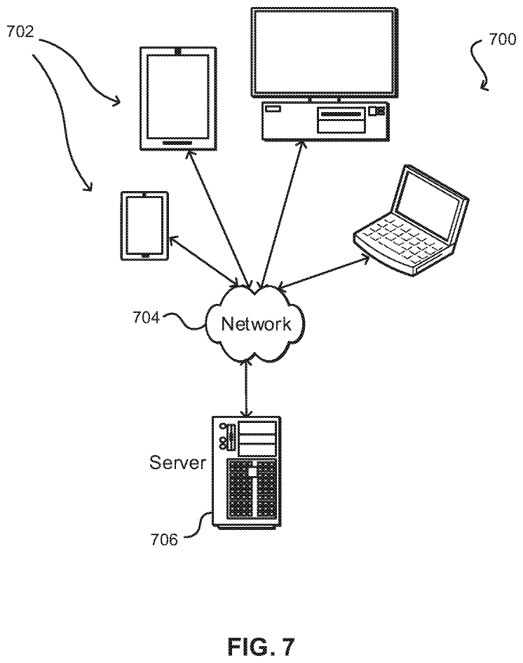

FIG. 1 conceptually illustrates an example interface 100 for presenting detected geological data integrity errors in accordance with some implementations. The interface 100 may be implemented and provided for display by one or more computing devices or systems in some implementations, such as a computing device 600 described in FIG. 6, and/or client device 702 or server 706 described in FIG. 7. The interface 100 may be provided locally on a device, and/or in conjunction with a remote device, such as a server.

As illustrated in FIG. 1, the interface 100 provides a graphical representation of geologic point datasets (e.g., well picks, or outcrop data) that may intersect with a polygon dataset depicting the geologic lithology of a geologic map. A geologic lithology may refer to, for example, a physical characteristic of a rock or rock formation.

The interface 100 includes a graphical representation of a geologic map 110 with points, corresponding to geologic point data, overlaying polygons of the geologic map 110. In the example of FIG. 1, many of the points (e.g., depicted as different circles) can be seen to correspond to the polygons which the points intersect, such as respective polygons in each of region 120, region 121, or region 122. Thus, multiple polygons can be included in each region of the geologic map 110. Further, as illustrated, each region shown in the geologic map 110 corresponds to a particular depositional environment and a confidence level corresponding to the depositional environment, such as deep marine claystone (high confidence), deep marine claystone (low confidence), shallow marine claystone (high confidence), etc. However, some points are shown to not intersect a polygon in the geologic map 110 (e.g., indicating that the geologic point data does not necessarily wholly coincide with data of the displayed polygons from the geologic map 110).

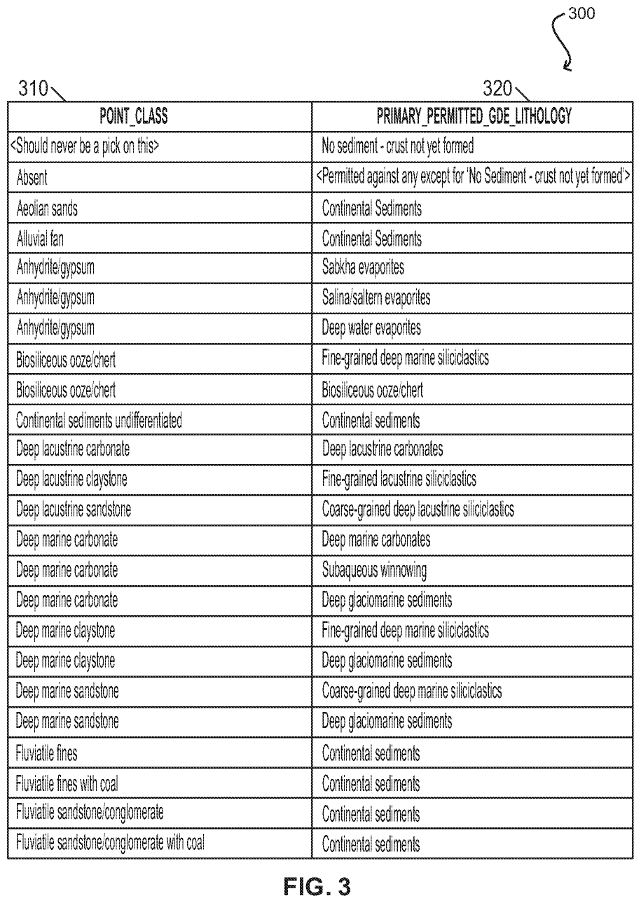

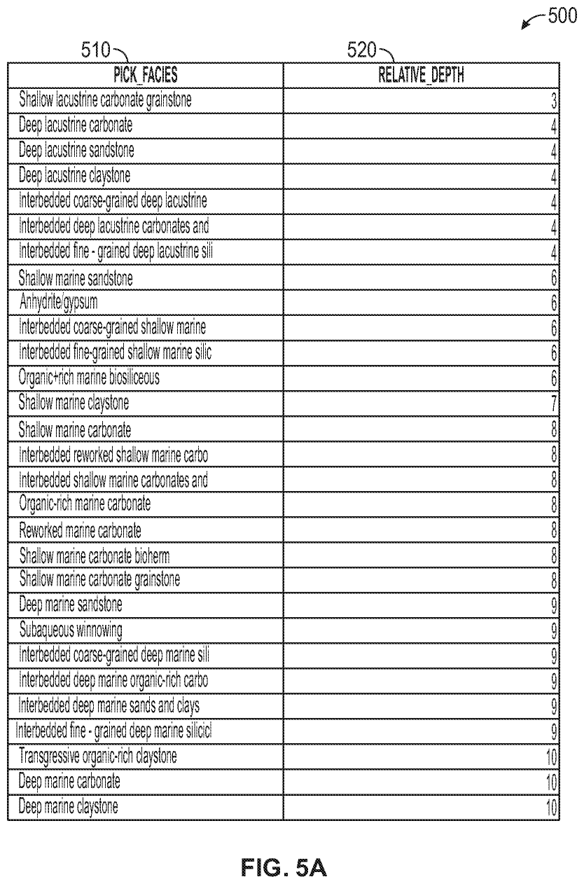

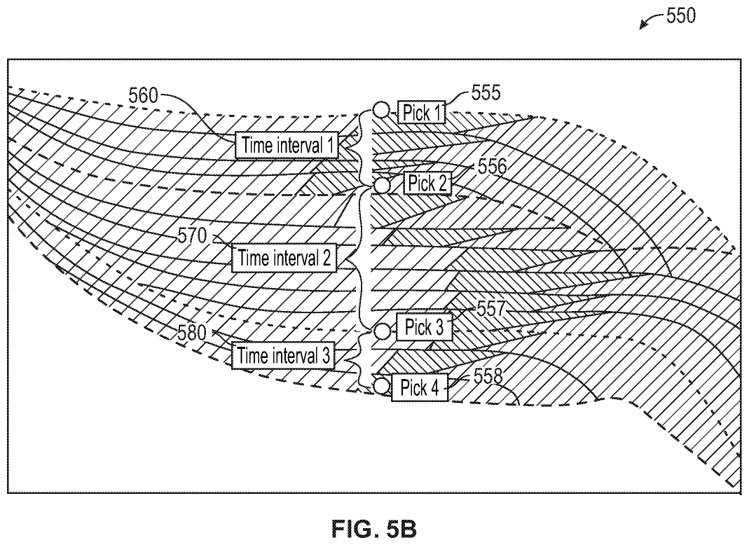

For each instance of an intersect between a point and a polygon, one or more sets of integrity checks (e.g., as discussed in FIG. 3 and FIG. 5A) are applied to assess whether a combination of 1) an attribute of a given point such as a lithologic attribute and 2) an attribute of a polygon (e.g., geologic map polygon) that the point intersects, complies with a corresponding integrity check. Such an integrity check may define a relationship between the attributes. Any point that fails a particular integrity check from the set of integrity checks may be highlighted or indicated in a particular manner in the geologic map 110.

In the example of FIG. 1, the interface 100 has indicated points 111, 112, 113, 114, 115, and 116 as failing a particular integrity check. As can be seen in the geologic map 110, the points 111, 112, 113, and 114 correspond to various locations within the region 120, and the points 115 and 116 correspond to various locations in the region 122, which can be more easily discerned by a user through viewing the interface 100.

Additionally, the interface 100 includes a geological information area 130 including a list of different lithology attributes corresponding to polygons in the geologic map 110. In this manner, the geological information area 130 may include information for interpreting different portions of the geologic map 110, and/or may include one or more filters for filtering the data presented on the geologic map 110.

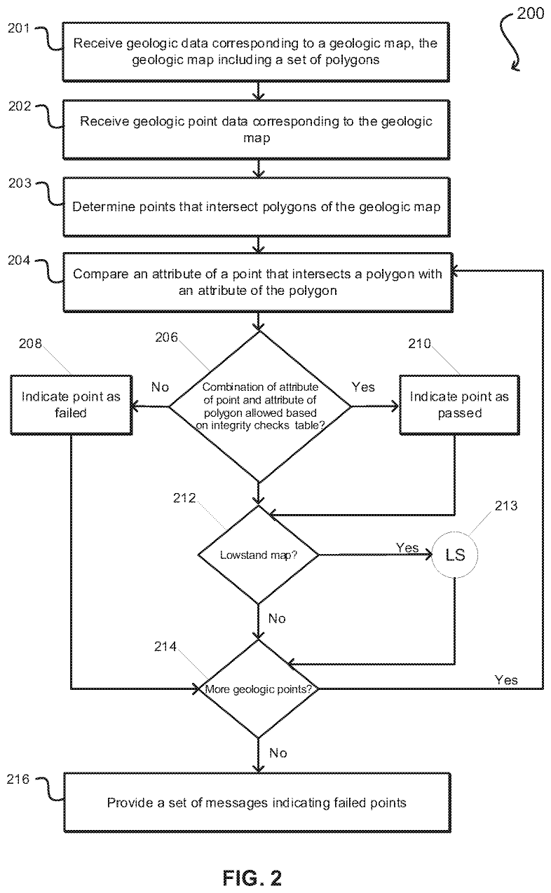

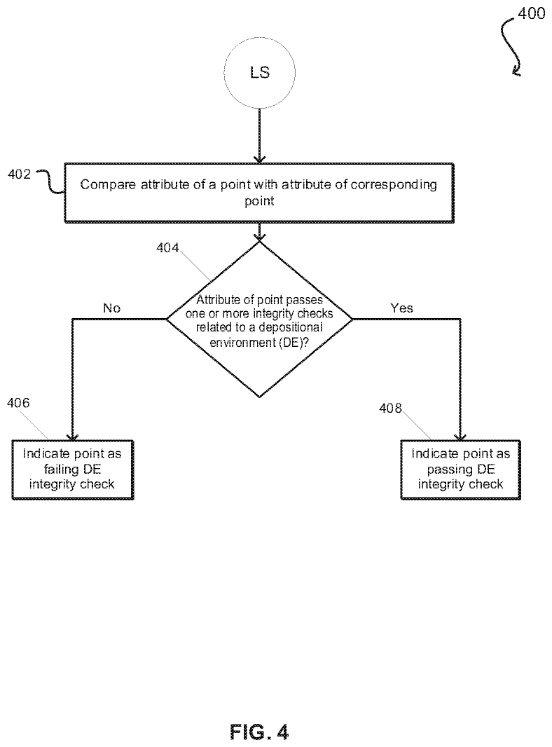

The interface 100 also includes an integrity check information area 140 with messages that indicate various integrity check failures with corresponding points and/or polygons. An example process discussing how the subject technology generates and provides such messages is discussed in further detail below in FIGS. 2 and 4. Each of these messages may respectively correspond to the points 111, 112, 113, 114, 115, and 116 discussed above and provide information that include a reason (e.g., textual information and/or graphical content) indicating why these points may have failed a particular integrity check.

Although the interface 100 is depicted in FIG. 1 as including a number of respective graphical elements for the geologic map 110, the geological information area 130, and/or the integrity check information area 140, it is appreciated that fewer and/or more graphical elements may be utilized. Further, the subject technology may also provide more than one interface (e.g., different and/or separate windows) for the geologic map 110, the geological information area 130, and/or the integrity check information area 140.

FIG. 2 conceptually illustrates an example flowchart of a process 200 of a geological data integrity verification system in accordance with some implementations. Although this figure, as well as other process illustrations contained in this disclosure may depict functional steps in a particular sequence, the processes are not necessarily limited to the particular order or steps illustrated. The various steps portrayed in this or other figures can be changed, rearranged, performed in parallel or adapted in various ways. Furthermore, it is to be understood that certain steps or sequences of steps can be added to or omitted from the process, without departing from the scope of the various implementations. The process 200 may be implemented by one or more computing devices or systems in some implementations, such as a computing device 600 described in FIG. 6, and/or client device 702 or server 706 described in FIG. 7. The process 200 of FIG. 2, in an example, may be performed in order to populate various graphical elements or portions provided in the interface 100 of FIG. 1.

At block 201, geologic data for a geologic map is received. The geologic data may include information representing to a set of polygons corresponding to the geologic map, such as geologic unit polygons. Additionally, the geologic data may include a lithology attribute of each polygon of the set of polygons. In an example, the geologic map data may be received from a storage source such as a relational database storing geologic data and/or a collection of files. In an example, geologic data is provided through processing data from one or more data sources of geologic data such as geophysical surveys (e.g., seismic data, magnetic surveys and/or gravity surveys, etc.), and/or other types of information from other maps (e.g., structural maps, isopach maps and/or lithofacies maps).

At block 202, geologic point data corresponding to the geologic map is received. The geologic point data may be derived from a geologic point dataset that includes one or more points corresponding to well picks from well logs of a subsurface area (e.g., respective points within different locations within a given subsurface), and/or one or more points corresponding to locations provided by outcrop data (e.g., rocks that are visible on the surface). Each point may have corresponding attributes such as a lithology attribute(s), depositional environment attribute, geographic coordinate information indicating a location, among other types of information. These sources of data may be stored locally or obtain at a different location (e.g., a server or in cloud storage). In some instances the geologic point data may additionally include points that correspond to other areas or locations from a particular location represented by the geologic map. Further, the geologic point data may include information indicating a particular lithology attribute associated with each of the set of points.

At block 203, a set of points intersecting one or more polygons of the geologic map is determined. In an example, the process 200 may determine the set of points from the received geologic point data such that each point from the set of points represents a particular location that intersects a particular polygon of the geologic map. For example, each point from the received geologic point data may include respective location information (e.g., geographic coordinates) to enable the determination of the set of points that intersects polygons of the geologic map. In an example, the coordinates of a given point are compared with an area of a geologic map polygon to determine whether the point intersects the geologic map polygon. Based on this comparison, the point is considered intersecting the geologic map polygon when the coordinates of the point fall within the area of the geologic map polygon.

At block 204, an attribute of a point that intersects a polygon is compared with an attribute of the polygon. If a combination of the attributes of the point and the polygon fails a corresponding integrity check (e.g., failing a corresponding integrity check from a table 300 as discussed further below in FIG. 3) at block 206, the point is indicated as having failed an integrity check in block 208. In this manner, an integrity check for a given geologic point is performed based at least in part on one or more lithologic attributes of the geologic map polygon and the intersecting geologic point.

In one or more implementations, when a point fails one or more integrity checks, the data corresponding to the point may be changed. For example, the attribute of the point may be changed, the point location may be changed, or the boundary of the polygon that the point intersects may be changed in order to resolve the conflict. In this manner the subject system is able to automatically resolve conflicts for the points that fail one or more integrity checks from the geologic map, thereby providing a more accurate geologic map to facilitate, for example, drilling operations.

Alternatively, if the combination of the attributes is passes one or more of the corresponding integrity checks (e.g., passing one or more corresponding integrity checks from the table 300 in FIG. 3) at block 206, the point is indicated as passed in the block 210.

If the point is indicated as having passed the one or more integrity checks, at block 212, it is determined whether the geologic map corresponds to a lowstand map. A lowstand map indicates a scenario where the received geologic map (e.g., from block 201) is associated with a second map. When in this lowstand scenario, both of these maps include geologic points from the same geographical area, but from two different slices in geologic time. Where there is corresponding oil well point data on both surfaces, those data points will come from the same hole. Thus, each data point will sit vertically (or in the real world at least close to vertically), one point above the other. In an example, this may be determined based on the inclusion of geologic point data for points related to a maximum regressive surface (MRS) and corresponding points related to a sequence boundary (SB). For such a lowstand map, the point discussed in FIG. 2 may correspond to the points related to the MRS, and this point may have a corresponding point related to the SB.

If the geologic map does correspond to a lowstand map, at block 213 the process 200 performs operations further described in connection with FIG. 4 discussed below for comparing the point related to the MRS with its corresponding point related to the SB. Alternatively or in addition, if the geologic map does not correspond to the lowstand map, at block 214 it is determined whether more points are included in the determined set of points (e.g., each point that intersects a polygon) for processing. If so, the process 200 may continue back to the block 204 and repeat the operations for another point that intersects a particular polygon. Alternatively, at block 216, a set of messages indicating one or more failed points may be provided (e.g., for display in the integrity check information area 140 of the interface 100). The set of messages may include information such as textual content, graphical content, and/or a combination of textual and graphical content in order to indicate a particular reason for one or more points failing respective rules. In some instances, a particular message can indicate that a particular point requires additional verifying, such as by a machine learning algorithm and/or a user, to resolve an issue or conflict between the attributes of the point and intersected polygon.

FIG. 3 illustrates an example table 300 including integrity checks for comparing attributes of points with attributes of intersected polygons in accordance with some implementations.

In the example of FIG. 3, the table 300 may include entries for time slice rules. A time slice (e.g., a maximum flooding surface or a geological event like the K-T (Cretaceous-Tertiary) boundary) may correspond to a snapshot of geological time and any point attributed to that time slice should be consistent with a map including geologic data from that geologic time (e.g., the time slice). In one or more implementations, a look-up table (e.g., the table 300) may be utilized to check a relationship between a point and a polygon that the point intersects. The table 300, when implemented as a look-up table, can enable more efficient verification of the combination of attributes of the point and the intersected polygon while also facilitating quicker identification of inconsistencies of such attributes based on the relationships provided in the table 300. Further, by applying the table 300 across different geologic point datasets and geologic maps, a more consistent interpretation of such geologic data may be provided.

In an example, a data field is provided containing one or more attributes that define a depositional environment for each geologic feature associated with a point. This data field value is compared with a lithology attribute of the polygon that the point intersects. If the combination is not valid, the point is indicated as having failed an integrity check. This indication of the point failing the integrity check may be accomplished by updating a separate data table, and the reason for the failure is also stored in the data table to aid in rectification of the integrity check failure.

As illustrated in the table 300, each point is attributed with a depositional environment, which is represented in a POINT_CLASS field of column 310. Each polygon is attributed with a primary lithology, which is listed in a PRIMARY_PERMITTED_GDE_LITHOLOGY field of column 320. In this manner, the table 300 includes valid combinations of an attribute of a point and an attribute of a polygon. For a given point and polygon that the point is intersecting, and the table 300 may be read to determine whether that combination of attributes is allowed or not. As shown in the table 300, a particular attribute of a point may correspond to several attributes for a polygon, indicating that several valid combinations of attributes between the point and a given polygon are possible. In one example, the table 300 may be converted into a dictionary data structure (e.g., an associative array), where the attribute of the point can be utilized to return a list of one or more valid attributes of a polygon.

The subject technology (e.g., the process 200) can determine whether the list of valid attributes includes the attribute of the polygon that is intersected by the point. If so, the point may be indicated as having passed the integrity check (e.g., at block 210), and if not, the point may be indicated is marked as failed the integrity check (e.g., at block 208). Additionally, a reason or message indicating the failure of the point may be generated and provided for display (e.g., at block 216). The table 300, in an example, is utilized for flood maps (e.g., which only have one type of point for a maximum flooding surface) and lowstand maps (e.g., which have two types of points associated with a maximum regressive surface and a sequence boundary).

FIG. 4 conceptually illustrates an example flowchart of a process 400 for comparing an attribute of a point with an attribute related to a depositional environment of an intersected polygon based on one or more integrity checks in accordance with some implementations. Although this figure, as well as other process illustrations contained in this disclosure may depict functional steps in a particular sequence, the processes are not necessarily limited to the particular order or steps illustrated. The various steps portrayed in this or other figures can be changed, rearranged, performed in parallel or adapted in various ways. Furthermore, it is to be understood that certain steps or sequences of steps can be added to or omitted from the process, without departing from the scope of the various implementations. The process 400 may be implemented by one or more computing devices or systems in some implementations, such as a computing device 600 described in FIG. 6, and/or client device 702 or server 706 described in FIG. 7. The process 400 of FIG. 4, in an example, may be performed in conjunction with the process 200 in FIG. 2 described above (e.g., to further process geologic data for a lowstand map continuing from block 213 in FIG. 2).

For a given lowstand map, there are two points being checked: 1) a point for maximum regressive surface (MRS) and, 2) a point for a sequence boundary (SB). In an example, geologic data corresponding to a given lowstand map includes respective geologic point data for the MRS and the SB in which a point related to the MRS (e.g., the “MRS point”) has a corresponding point related to the SB (e.g., the “SB point”). The point related to the MRS, as discussed above, is checked against a rule as described in FIG. 2, and if this point passes the rule, the attribute of the SB point is compared to the attribute of the MRS point.

At block 402, an attribute related to a depositional environment associated with a particular point is compared with an attribute related to the depositional environment associated with a corresponding point from the determined set of points (e.g., from block 203). The particular point discussed in FIG. 4, in an example, may be related to the SB, and the corresponding point may be related to the MRS.

At block 404, it is determined whether a combination of the compared attributes of the two aforementioned points from block 402 passes one or more integrity checks related to a depositional environment (DE). In an example, time intervals (e.g., a period of geologic time or a systems tract) differ from the previously discussed time slices as there may be multiple points with geologic features that share the same location, fall within the same time interval, and which may be attributed differently, yet all of which could be compatible with the polygon that such points intersect. As an example, in sequence stratigraphy, a lowstand map may have two separate lowstand point datasets representing MRS and SB points.

The same integrity check-base as used for the time slice scenario is applied (e.g., the table 300 in FIG. 3), and at block 404 additional and more complex integrity checks are applied to account for the potential shift in geologic facies over the interval of time being analyzed. These additional integrity checks may take into account the attribution of the other lowstand point dataset in the time range (e.g., for MRS and SB points), which shares the same location, and may also differ depending upon the attribution of the polygon being intersected. A description of eleven (11) additional example integrity checks related to depositional environment data is included the following discussion.

In a first integrity check, when a MRS point matches the polygon from the geologic map (e.g., using the table 300): a point boundary attribute of a corresponding SB point should be the same or deeper than the point boundary attribute of the MRS point, otherwise indicate that the SB point as failing this integrity check. In an example, the SB point is checked against a table including attributes for relative depth of a depositional environment (e.g., table 500 in FIG. 5A). If the relative depth value associated with the SB point in the relative depth table is the same or deeper than the relative depth of its associated MRS point, then the SB point passes the first integrity check, and if not, the SB point fails the first integrity check.

In a second integrity check, when a MRS point matches the polygon from the geologic map (e.g., using the table 300): if a MRS point is a halite/potash lithology, a corresponding SB point cannot be of an anhydrite/gypsum lithology. This integrity check may be checked only when the first integrity check has been passed. Thus, in this case, both the MRS and SB points have passed the first integrity check above. Notwithstanding passing the first integrity check, if the MRS point is attributed to the halite/potash lithology, the SB point cannot be attributed to the anhydrite/gypsum lithology. However, if the SB point is attributed to the anhydrite/gypsum lithology, then the SB point is indicated as failing the second integrity check.

In a third integrity check, when a MRS point matches the polygon from the geologic map (e.g., using the table 300): if a MRS point is related to a deep lacustrine/marine environment, the corresponding SB point cannot be an anhydrite/gypsum or halite/potash lithology. This integrity check is checked only if the previous integrity checks have been passed. If the MRS point is related to a deep lacustrine/marine environment, the corresponding SB point cannot be of the anhydrite/gypsum or halite/potash lithology. If the SB point is attributed as such, the SB point is indicated as a fail.

In a fourth integrity check, when a MRS point matches the polygon from the geologic map (e.g., using the table 300) and it is not an anhydrite/gypsum or halite/potash lithology: if the associated SB point is an anhydrite/gypsum or halite/potash lithology, indicate the MRS point for manual checking by a user. This integrity check is performed only if the previous integrity checks have been passed. Notwithstanding the MRS point having passed the above integrity checks, if the MRS point is not attributed to the anhydrite/gypsum or halite/potash lithology, the MRS point will be indicated for manual checking by a user if its associated SB point is attributed as the anhydrite/gypsum or halite/potash lithology.

In a fifth integrity check, if a MRS point fails against the polygon from the geologic map using the above integrity check list: indicate the MRS point as a fail. In a sixth integrity check, if a MRS point fails against the polygon from the geologic map using the above integrity check list: check that the corresponding SB point matches the integrity check of the polygon that it intersects (e.g., using the table 300), and if the SB point does not pass this integrity check then indicate the SB point as a fail.

In a seventh integrity check, if no MRS point is present: if a SB point intersects a polygon from the geologic map that relates to a non-marine or non-lacustrine environment, the SB point should match the polygon from the geologic map according to integrity check of the polygon that it intersects (e.g., using the table 300), and if the SB point does not pass this integrity check then indicate the SB point as a fail.

In an eighth integrity check, if no MRS point is present: if a SB point intersects polygon from the geologic map that is a marine or lacustrine environment, indicate the SB point for manual checking by a user.

In a ninth integrity check, it is determined that all MRS points are processed before SB points (other than those SB points that are checked immediately after a related MRS point). This integrity check states that the integrity checks are applied such that all MRS points are being processed before SB points (other than those SB points that are checked immediately after a related MRS point). If this integrity check was not enforced, then SB points might be checked before knowing the pass/fail status of their associated MRS points, and thus the integrity checks could not be applied correctly.

In a tenth integrity check, if a MRS point is present, check that there is a corresponding SB point. If not, indicate the MRS point as a fail to ensure that a corresponding SB point is added to the geologic point dataset because a maximum regressive surface does not exist without an associated sequence boundary surface.

In an eleventh integrity check, if no MRS point is present: if a SB point is picked ‘deep’, there should be a MRS point too, and the SB point is indicated as not failing itself, but indicated for manual checking by a user, as the user (e.g., geoscientist) will likely need to add a MRS point and its attribute(s) to the geologic point dataset.

At block 406, the particular point (e.g., the SB point) is indicated as failing the DE integrity check when the combination of compared attributes fails a particular integrity check in accordance with the discussion above. In some implementations, a message indicating that the particular point has failed the particular integrity check is generated and provided for display, such as via the interface 100. Alternatively, at block 408, the particular point is indicated as having passed the integrity check when the when the combination of compared attributes passes one or more previous discussed DE integrity checks.

FIG. 5A illustrates an example table 500 including attributes for a relative depth of a depositional environment in accordance with some implementations. As discussed above, the table 500 may be utilized by the process 400 in FIG. 4 (e.g., for determining whether a relative depth value associated with a SB point is the same or deeper than the relative depth of its associated MRS point).

As illustrated in the table 500, a depositional environment attribute is represented in a PICK_FACIES field of column 510. Each depositional environment attribute is attributed with a relative depth, which is listed in a RELATIVE_DEPTH field of column 520. In some implementations, each point includes a depositional environment attribute assigned to the point, the table 500 functions as look up table that allows for quick querying to determine a relative depth of a depositional environment corresponding to the depositional environment attribute of the point. In an example, the table 500 is utilized when applied against a given lowstand map. For a given lowstand map that relates to a timespan, two different points (e.g., a MRS point and its corresponding SB point) are checked for a polygon that the two points intersect (e.g., using one or more integrity checks described above in FIG. 4).

FIG. 5B illustrates an example schematic diagram of a cross-section 550 through depositional sequences with time intervals in accordance with some implementations. As illustrated, the cross-section 550 includes various picks 555, 556, 557, and 558. Each of the picks 555, 556, 557, and 558 correspond to depth points in the strata with geologic attributes. A time interval 560 may be defined by one or more points that lie between the pick 555 and the pick 556. Similarly, a time interval 570 may be defined by one or more points that lie between the pick 556 and the pick 557, and deeper in depth than the points within the time interval 560. Even further in depth, a time interval 580 may be defined by one or more points that lie between the pick 557 and the pick 558. Within a same time interval, a given MRS point and its corresponding SB point may be included. In an example, the MRS point and the SB point may be positioned vertically in a line within the same time interval and with the MRS point being above the SB point.

FIG. 6 illustrates a schematic diagram of a set of general components of an example computing device 600. In this example, the computing device 600 includes a processor 602 for executing instructions that can be stored in a memory device or element 604. The computing device 600 can include many types of memory, data storage, or non-transitory computer-readable storage media, such as a first data storage for program instructions for execution by the processor 602, a separate storage for images or data, a removable memory for sharing information with other devices, etc.

The computing device 600 typically may include some type of display element 606, such as a touch screen or liquid crystal display (LCD). As discussed, the computing device 600 in many embodiments will include at least one input element 610 able to receive conventional input from a user. This conventional input can include, for example, a push button, touch pad, touch screen, wheel, joystick, keyboard, mouse, keypad, or any other such device or element whereby a user can input a command to the device. In some embodiments, however, such the computing device 600 might not include any buttons at all, and might be controlled only through a combination of visual and audio commands, such that a user can control the computing device 600 without having to be in contact with the computing device 600. In some embodiments, the computing device 600 of FIG. 6 can include one or more network interface elements 608 for communicating over various networks, such as a Wi-Fi, Bluetooth, RF, wired, or wireless communication systems. The computing device 600 in many embodiments can communicate with a network, such as the Internet, and may be able to communicate with other such computing devices.

As discussed herein, different approaches can be implemented in various environments in accordance with the described embodiments. For example, FIG. 7 illustrates a schematic diagram of an example of an environment 700 for implementing aspects in accordance with various embodiments. As will be appreciated, although a client-server based environment is used for purposes of explanation, different environments may be used, as appropriate, to implement various embodiments. The system includes an electronic client device 702, which can include any appropriate device operable to send and receive requests, messages or information over an appropriate network 704 and convey information back to a user of the device. Examples of such client devices include personal computers, cell phones, handheld messaging devices, laptop computers, set-top boxes, personal data assistants, electronic book readers and the like.

The network 704 can be apparent to one of ordinary skill in the art.

The client device 702 may represent the computing device 600 of FIG. 6, and the server 706 may represent off-site computing include any appropriate network, including an intranet, the Internet, a cellular network, a local area network or any other such network or combination thereof. The network 704 could be a “push” network, a “pull” network, or a combination thereof. In a “push” network, one or more of the servers push out data to the client device. In a “pull” network, one or more of the servers send data to the client device upon request for the data by the client device. Components used for such a system can depend at least in part upon the type of network and/or environment selected. Protocols and components for communicating via such a network are well known and will not be discussed herein in detail. Computing over the network 704 can be enabled via wired or wireless connections and combinations thereof. In this example, the network includes the Internet, as the environment includes a server 706 for receiving requests and serving content in response thereto, although for other networks, an alternative device serving a similar purpose could be used, as would facilities in other implementations.

The server 706 typically will include an operating system that provides executable program instructions for the general administration and operation of that server and typically will include computer-readable medium storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via computing links, using one or more computer networks or direct connections. However, it will be appreciated by those of ordinary skill in the art that such a system could operate equally well in a system having fewer or a greater number of components than are illustrated in FIG. 7. Thus, the depiction of the environment 700 in FIG. 7 should be taken as being illustrative in nature and not limiting to the scope of the disclosure.

Storage media and other non-transitory computer readable media for containing code, or portions of code, can include any appropriate storage media used in the art, such as but not limited to volatile and non-volatile, removable and non-removable media implemented in any method or technology for storage of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by the a system device. Based on the disclosure and teachings provided herein, a person of ordinary skill in the art will appreciate other ways and/or methods to implement the various implementations.

### Further Considerations

Various examples of aspects of the disclosure are described below as clauses for convenience. The methods of any preceding paragraph, either alone or in combination may further include the following clauses. These are provided as examples, and do not limit the subject technology.

Clause 1. A method comprising: receiving a geologic point corresponding to at least one of a well pick or outcrop data, the geologic point being associated with a lithologic attribute; intersecting the geologic point with a geologic map polygon to identify an intersecting geologic point of the geologic map polygon, the intersecting geologic point being associated with a lithologic attribute and the geologic map polygon corresponding to a formation; performing an integrity check for the geologic point based at least in part on the lithologic attributes of the geologic point and the intersecting geologic point; and when the geologic point fails the integrity check, providing an indication that the geologic point failed the integrity check to facilitate providing an accurate representation of the formation corresponding to the geologic map polygon.

Clause 2. The method of Clause 1, further comprising: when the integrity check of the geologic point fails, removing the geologic point from a geologic point dataset to facilitate a drilling operation in the formation corresponding to the geologic map polygon.

Clause 3. The method of Clause 1, wherein providing the indication that the geologic point failed the integrity check further comprises: providing a set of messages indicating that the geologic point failed the integrity check.

Clause 4. The method of Clause 1, wherein performing the integrity check for the geologic point based at least in part on the lithologic attributes of the geologic point and the intersecting geologic point further comprises: comparing the lithologic attributes of the geologic point and the intersecting geologic point.

Clause 5. The method of Clause 4, wherein the integrity check is based on information indicating whether a combination of the lithologic attributes of the geologic point and the intersecting geologic point is valid.

Clause 6. The method of Clause 1, further comprising: providing for display a graphical representation of a set of geologic map polygons of a geologic map; and providing for display respective graphical representations of one or more geologic points that failed at least one integrity check, the respective graphical representations of the one or more geologic points overlaying the graphical representation of the set of geologic map polygons.

Clause 7. The method of Clause 6, further comprising: providing for display a set of messages indicating that the one or more geologic points failed at least one integrity check.

Clause 8. The method of Clause 7, wherein the set of messages includes an error message related to a maximum regressive surface or a sequence boundary.

Clause 9. The method of Clause 1, further comprising: determining that the geologic map polygon corresponds to a lowstand map, wherein the intersecting geologic point includes information corresponding to a second geologic point associated with the intersecting geologic point; comparing an attribute related to a depositional environment associated with the second geologic point with an attribute related to the depositional environment associated with the intersecting geologic point; determining that the second geologic point has failed a particular integrity check related to the depositional environment based at least in part on the comparing; and providing a message indicating that the second geologic point has failed the particular integrity check related to the depositional environment in response to the determining.

Clause 10. The method of Clause 9, wherein the attribute related to the depositional environment comprises an indicator of depth of the depositional environment.

Clause 11. A system comprising: a processor; and a memory device including instructions that, when executed by the processor, cause the processor to: receive a geologic point corresponding to at least one of a well pick or outcrop data, the geologic point being associated with a lithologic attribute; intersect the geologic point with a geologic map polygon to identify an intersecting geologic point of the geologic map polygon, the intersecting geologic point being associated with a lithologic attribute and the geologic map polygon corresponding to a formation; perform an integrity check for the geologic point based at least in part on the lithologic attributes of the geologic point and the intersecting geologic point; and when the geologic point fails the integrity check, provide an indication that the geologic point failed the integrity check to facilitate providing an accurate representation of the formation corresponding to the geologic map polygon.

Clause 12. The system of Clause 11, wherein the instructions further cause the processor to: when the integrity check of the geologic point fails, remove the geologic point from a geologic point dataset to facilitate a drilling operation in the formation corresponding to the geologic map polygon.

Clause 13. The system of Clause 11, wherein to provide the indication that the geologic point failed the integrity check further causes the processor to: provide a set of messages indicating that the geologic point failed the integrity check.

Clause 14. The system of Clause 11, wherein to perform the integrity check for the geologic point based at least in part on the lithologic attributes of the geologic point and the intersecting geologic point further causes the processor to: compare the lithologic attributes of the geologic point and the intersecting geologic point.

Clause 15. The system of Clause 14, wherein the integrity check is based on information indicating whether a combination of the lithologic attributes of the geologic point and the intersecting geologic point is valid.

Clause 16. The system of Clause 11, wherein the instructions further cause the processor to: provide for display a graphical representation of a set of geologic map polygons of a geologic map; and provide for display respective graphical representations of one or more geologic points that failed at least one integrity check, the respective graphical representations of the one or more geologic points overlaying the graphical representation of the set of geologic map polygons.

Clause 17. The system of Clause 16, wherein the instructions further cause the processor to: provide for display a set of messages indicating that the one or more geologic points failed at least one integrity check.

Clause 18. The system of Clause 17, wherein the set of messages includes an error message related to a maximum regressive surface or a sequence boundary.

Clause 19. The system of Clause 18, wherein the instructions further cause the processor to: determine that the geologic map polygon corresponds to a lowstand map, wherein the intersecting geologic point includes information corresponding to a second geologic point associated with the intersecting geologic point; compare an attribute related to a depositional environment associated with the second geologic point with an attribute related to the depositional environment associated with the intersecting geologic point; determine that the second geologic point has failed a particular integrity check related to the depositional environment based at least in part on the comparing; and provide a message indicating that the second geologic point has failed the particular integrity check related to the depositional environment in response to the determining.

Clause 20. A non-transitory computer-readable medium including instructions stored therein that, when executed by at least one computing device, cause the at least one computing device to: receiving a geologic point corresponding to at least one of a well pick or outcrop data, the geologic point being associated with a lithologic attribute; intersecting the geologic point with a geologic map polygon to identify an intersecting geologic point of the geologic map polygon, the intersecting geologic point being associated with a lithologic attribute and the geologic map polygon corresponding to a formation; performing an integrity check for the geologic point based at least in part on the lithologic attributes of the geologic point and the intersecting geologic point; and when the geologic point fails the integrity check, providing an indication that the geologic point failed the integrity check to facilitate providing an accurate representation of the formation corresponding to the geologic map polygon.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A method comprising:
receiving a geologic point corresponding to at least one of a well pick or outcrop data, the geologic point being associated with a lithologic attribute;
intersecting the geologic point with a geologic map polygon to identify an intersecting geologic point of the geologic map polygon, the intersecting geologic point being associated with a lithologic attribute and the geologic map polygon corresponding to a formation;
performing an integrity check for the geologic point based at least in part on the lithologic attributes of the geologic point and the intersecting geologic point; and
when the geologic point fails the integrity check, providing an indication that the geologic point failed the integrity check to facilitate providing an accurate representation of the formation corresponding to the geologic map polygon.

2. The method of claim 1, further comprising:
when the integrity check of the geologic point fails, removing the geologic point from a geologic point dataset to facilitate a drilling operation in the formation corresponding to the geologic map polygon.

3. The method of claim 1, wherein providing the indication that the geologic point failed the integrity check further comprises:
providing a set of messages indicating that the geologic point failed the integrity check.

4. The method of claim 1, wherein performing the integrity check for the geologic point based at least in part on the lithologic attributes of the geologic point and the intersecting geologic point further comprises:
comparing the lithologic attributes of the geologic point and the intersecting geologic point.

5. The method of claim 4, wherein the integrity check is based on information indicating whether a combination of the lithologic attributes of the geologic point and the intersecting geologic point is valid.

6. The method of claim 1, further comprising:
providing for display a graphical representation of a set of geologic map polygons of a geologic map; and
providing for display respective graphical representations of one or more geologic points that failed at least one integrity check, the respective graphical representations of the one or more geologic points overlaying the graphical representation of the set of geologic map polygons.

7. The method of claim 6, further comprising:
providing for display a set of messages indicating that the one or more geologic points failed at least one integrity check.

8. The method of claim 7, wherein the set of messages includes an error message related to a maximum regressive surface or a sequence boundary.

9. The method of claim 1, further comprising:
determining that the geologic map polygon corresponds to a lowstand map, wherein the intersecting geologic point includes information corresponding to a second geologic point associated with the intersecting geologic point;
comparing an attribute related to a depositional environment associated with the second geologic point with an attribute related to the depositional environment associated with the intersecting geologic point;
determining that the second geologic point has failed a particular integrity check related to the depositional environment based at least in part on the comparing; and
providing a message indicating that the second geologic point has failed the particular integrity check related to the depositional environment in response to the determining.

10. The method of claim 9, wherein the attribute related to the depositional environment comprises an indicator of depth of the depositional environment.

11. A system comprising:
a processor; and
a memory device including instructions that, when executed by the processor, cause the processor to:
receive a geologic point corresponding to at least one of a well pick or outcrop data, the geologic point being associated with a lithologic attribute;
intersect the geologic point with a geologic map polygon to identify an intersecting geologic point of the geologic map polygon, the intersecting geologic point being associated with a lithologic attribute and the geologic map polygon corresponding to a formation;
perform an integrity check for the geologic point based at least in part on the lithologic attributes of the geologic point and the intersecting geologic point; and
when the geologic point fails the integrity check, provide an indication that the geologic point failed the integrity check to facilitate providing an accurate representation of the formation corresponding to the geologic map polygon.

12. The system of claim 11, wherein the instructions further cause the processor to:
when the integrity check of the geologic point fails, remove the geologic point from a geologic point dataset to facilitate a drilling operation in the formation corresponding to the geologic map polygon.

13. The system of claim 11, wherein to provide the indication that the geologic point failed the integrity check further causes the processor to:
provide a set of messages indicating that the geologic point failed the integrity check.

14. The system of claim 11, wherein to perform the integrity check for the geologic point based at least in part on the lithologic attributes of the geologic point and the intersecting geologic point further causes the processor to:
compare the lithologic attributes of the geologic point and the intersecting geologic point.

15. The system of claim 14, wherein the integrity check is based on information indicating whether a combination of the lithologic attributes of the geologic point and the intersecting geologic point is valid.

16. The system of claim 11, wherein the instructions further cause the processor to:
provide for display a graphical representation of a set of geologic map polygons of a geologic map; and
provide for display respective graphical representations of one or more geologic points that failed at least one integrity check, the respective graphical representations of the one or more geologic points overlaying the graphical representation of the set of geologic map polygons.

17. The system of claim 16, wherein the instructions further cause the processor to:
provide for display a set of messages indicating that the one or more geologic points failed at least one integrity check.

18. The system of claim 17, wherein the set of messages includes an error message related to a maximum regressive surface or a sequence boundary.

19. The system of claim 18, wherein the instructions further cause the processor to:
determine that the geologic map polygon corresponds to a lowstand map, wherein the intersecting geologic point includes information corresponding to a second geologic point associated with the intersecting geologic point;
compare an attribute related to a depositional environment associated with the second geologic point with an attribute related to the depositional environment associated with the intersecting geologic point;
determine that the second geologic point has failed a particular integrity check related to the depositional environment based at least in part on the comparing; and
provide a message indicating that the second geologic point has failed the particular integrity check related to the depositional environment in response to the determining.

20. A non-transitory computer-readable medium including instructions stored therein that, when executed by at least one computing device, cause the at least one computing device to:
receiving a geologic point corresponding to at least one of a well pick or outcrop data, the geologic point being associated with a lithologic attribute;
intersecting the geologic point with a geologic map polygon to identify an intersecting geologic point of the geologic map polygon, the intersecting geologic point being associated with a lithologic attribute and the geologic map polygon corresponding to a formation;
performing an integrity check for the geologic point based at least in part on the lithologic attributes of the geologic point and the intersecting geologic point; and
when the geologic point fails the integrity check, providing an indication that the geologic point failed the integrity check to facilitate providing an accurate representation of the formation corresponding to the geologic map polygon.
